(19) United States
(12) Patent Application Publication
(10) Pub. No.: US 2024/0429845 A1
(43) Pub. Date: Dec. 26, 2024

(54) Parameter Identification Method for Synchronous Motor Based on Neural Network

(71) Applicants: Yu CHEN, Wuhan, Hubei (CN); Siyu TONG, Wuhan, Hubei (CN); Xiaoyun ZANG, Shanghai (CN); Robert Bosch GmbH, Stuttgart (DE)

(72) Inventors: Yu Chen, Hubei (CN); Siyu Tong, Hubei (CN); Xiaoyun Zang, Shanghai (CN)

(21) Appl. No.: 18/690,870

(22) PCT Filed: Sep. 28, 2021
(86) PCT No.: PCT/CN2021/121272

§ 371 Date: Mar. 11, 2024

(51) Int. Cl. H02P 23/00; G06N 3/045; G06N 3/084; H02P 23/14

(52) U.S. Cl. CPC H02P 23/0018; G06N 3/045; G06N 3/084; H02P 23/14

(57) ABSTRACT

A parameter identification method for a synchronous motor based on a neural network is disclosed. A method for parameter identification of synchronous motors based on neural networks includes: S1) establishing and training a first neural network model to determine intermediate results of the parameters to be identified for the synchronous motor, S2) forming a second neural network model by adding a compensation module to the trained first neural network model, S3) training the second neural network model based on the intermediate results of the parameters to be identified, and determining the final results of the parameters to be identified using the trained second neural network model. Also disclosed is a device and a computer program product for parameter identification of synchronous motors based on neural networks.

### TECHNICAL FIELD

The present invention relates to a method for parameter identification of a synchronous motor based on a neural network, a device for parameter identification of a synchronous motor based on a neural network, and a computer program product.

### BACKGROUND TECHNOLOGY

Synchronous motors have gained increasing attention in industrial applications due to their low cost, high efficiency, and high stability. However, when a synchronous motor operates under load, various motor parameters exhibit nonlinear characteristics due to reasons such as magnetic saturations, temperature drifts, and cross-couplings, making traditional linear models unable to accurately reflect the motor's true dynamic characteristics. In such cases, parameter identification of synchronous motors is required to achieve better control performance.

In prior art, motor parameters are often modeled in the form of lookup tables, but this requires traversing the full range of motor operating points, which is time-consuming and costly. Moreover, there are methods using mathematical models or special formulas to fit the nonlinear inductance surface. However, these mathematical models or formulas are often very complex, their coefficients are parameterized, and the curve plotting algorithm requires corresponding database support.

In this context, there is a need for an alternative motor parameter identification method that achieves good parameter fitting with a limited number of operating points.

### SUMMARY OF INVENTION

The object of the present invention is to provide a method for parameter identification of a synchronous motor based on a neural network, a device for parameter identification of a synchronous motor based on a neural network, and a computer program product, at least to solve some of the problems in the prior art.

According to a first aspect of the present invention, a method for parameter identification of a synchronous motor based on a neural network is provided, the method comprising the following steps:
S1) Establishing and training a first neural network model to determine intermediate results of parameters to be identified for the synchronous motor using the trained first neural network model;
S2) Forming a second neural network model by adding a compensation module to the trained first neural network model; and
S3) Training the second neural network model based on the intermediate results of the parameters to be identified to determine the final results of the parameters to be identified using the trained second neural network model.

The present invention particularly relates to the following technical concepts: a method for establishing a parameter model for a motor using a neural network. It utilizes the self-learning capability and fuzzy logic of artificial neural networks to optimize and estimate model parameters in cases with limited observation data and a small number of operating points, thus improving the efficiency and accuracy of parameter identification. Furthermore, a two-stage model training process is proposed for parameter estimation, enabling the allocation of different task priorities and better fitting of various characteristics of unknown parameters.

Optionally, intermediate results include:
a linear approximation value of a first parameter in the parameters to be identified; and
a first estimated value of a second parameter under the linear approximation of the first parameter.

Optionally, final results include:
the linear approximation value of the first parameter in the parameters to be identified after being compensated for nonlinearity; and
a second estimated value of the second parameter in the parameters to be identified after compensating for the nonlinearity of the linear approximation value of the first parameter.

The present invention achieves the following technical advantages: by utilizing the parameter identification process of the first neural network model and the second neural network model, the decoupling analysis of linear and nonlinear features of unknown parameters of the motor is realized, simplifying the identification principle.

Optionally, different training data are used for the training of the first neural network model and the second neural network model.

The following advantages are particularly achieved: the linear characteristics of unknown parameters are fitted based on observation data under magnetic unsaturation, and observation data under magnetic saturation are used for nonlinear compensation, thus accelerating the network convergence process.

Optionally, the parameters to be identified for the synchronous motor include stator resistance, d-axis inductance, q-axis inductance, and permanent magnet flux.

The following technical advantages are particularly achieved: different from the parameter identification method using a lookup table, the proposed scheme can achieve synchronous identification of multiple motor parameters, thus eliminating the need for additional sensors to pre-detect some fixed parameters, saving time and expenses.

Optionally, step S1 includes establishing an input-output relationship for the first neural network model based on the static voltage state equations of the synchronous motor in the d-q coordinate system, wherein the q-axis current, d-axis current, and the synchronous motor's electrical angular velocity are used as inputs to the first neural network model, and the q-axis voltage and d-axis voltage are used as outputs of the first neural network model, and at least partially represent the weights of the first neural network model through the parameters to be identified.

The following technical advantages are particularly achieved: through supervised learning, artificial neural networks can have a good input-output mapping relationship, generate reasonable outputs for new inputs, and continuously optimize their performance during the learning process, effectively utilizing existing data patterns with very limited samples, thereby speeding up the parameter identification process.

Optionally, step S1 includes:
obtaining known observation data of the synchronous motor, wherein the known observation data includes the d-axis current, q-axis current, d-axis voltage, q-axis voltage, and electrical angular velocity of the synchronous motor measured at different operating points;
training the first neural network model using the known observation data, wherein adjusting the weights of the first neural network model until the loss function satisfies a first predetermined condition; and
determining intermediate results of the parameters to be identified of the synchronous motor based on the weights of the first neural network model when the loss function satisfies the first predetermined condition.

The following technical advantages are particularly achieved: during this period, the unknown parameters of the system are reflected in the internal weights, thereby avoiding the direct identification of the unknown parameters of the controlled object.

Optionally, adjusting the weights of the first neural network model includes iteratively updating the weights of the first neural network model using a gradient descent algorithm, particularly a backpropagation algorithm.

The following technical advantages are particularly achieved: through the above algorithm, “reasonable” solution rules can be automatically extracted based on the known input-output relationship, and hence automatically determining the internal weights, resolving the mapping problem with complex internal mechanisms, and enabling the network to have good generalization and fault tolerance capabilities.

Optionally, step S2 includes: establishing a third neural network model as the compensation module, using q-axis current and d-axis current as inputs to the third neural network model and using the nonlinear characteristic portion of the parameters to be identified as the output of the third neural network model.

The following technical advantages are particularly achieved: by introducing the compensation module, it is possible to reasonably compensate for the nonlinear factors included under the assumption of parameter linearity, and it is also possible to create a dedicated mathematical model for the nonlinear characteristics of the parameters, thus making the final parameter identification result more reliable.

Optionally, step S2 includes: adding the compensation module to the first neural network model in the following way: sharing a part of the input layer of the first neural network model with the input layer of the compensation module, and connecting the output layer of the compensation module to the output layer of the first neural network model.

The following technical advantages are particularly achieved: by embedding the compensation module into the first neural network model through shared inputs and outputs, the compensation module is passively trained during the overall training process of the second neural network model. As a result, the unknown nonlinear characteristics of the parameters are transformed into the internal parameters of the model for solution. Without data available for direct training, the compensation module's input-output mapping relationship is indirectly established through the overall backpropagation capability of the network.

Optionally, step S3 includes:
training the second neural network model using known observation data, wherein adjusting the weights of the trained first neural network model and the weight of the compensation module until the loss function satisfies a second predetermined condition; and
determining the final results of the parameters to be identified of the synchronous motor based on the weights of the trained second neural network model and the weight of the compensation module when the loss function satisfies the second predetermined condition.

The following technical advantages are particularly achieved: the training of the second neural network model is based on the results of the training in the first stage, which allows for refinement based on the intermediate results of the parameters to be identified, improving time efficiency, and speeding up the convergence process.

Optionally, while adjusting the weights of the trained first neural network model, the intermediate results of the first parameter in the parameters to be identified are kept unchanged, and the intermediate results of the second parameter in the parameters to be identified are changed.

The following technical advantages are particularly achieved: since the parameter estimation in the first stage is completed under the linear approximation of specific parameters, in order to distinguish it well from the nonlinear characteristic portion during the compensation stage, it can continue to be regarded as a constant and not participate in the further training process. However, since this linear approximation is not accurate enough, it is possible that the intermediate results of certain fixed parameters incorrectly contain the nonlinear contributions of specific parameters. In order to compensate for parts that do not belong to these fixed parameters, it is necessary to adjust these fixed parameters in the second stage to remove interference.

Optionally, the loss function is represented by the following formula:

$$J = {\sum }_{0}^{N} {( {U}_{sd} - {\hat{U}}_{sd} )}^{2} + {( {U}_{sq} - {\hat{U}}_{sq} )}^{2}$$

where N is the number of known observation data used, U_{sd} is the d-axis voltage of the synchronous motor in the known observation data, Û_{sd} is the d-axis voltage output by the first or second neural network model, U_{sq} is the q-axis voltage of the synchronous motor in the known observation data, and Û_{sq} is the q-axis voltage output by the first or second neural network model.

The following technical advantages are particularly achieved: the error between the model output and the actual output can be effectively considered and utilized, enabling the model to continuously self-learn towards the direction of approaching the real values, providing a reliable evaluation criterion and termination condition for the training process.

Optionally, the method further includes the following steps:
sending the final results of the parameters to be identified to the controller of the synchronous motor to control the operation of the synchronous motor based on the final results; and/or
sending the weights of the trained second neural network model to the internal neural network of the controller of the synchronous motor, allowing the internal neural network to determine the online final results of the parameters to be identified based on the operation parameters of the synchronous motor in real time when applying the weights, enabling the controller to control the operation of the synchronous motor based on the online final results.

The following technical advantages are particularly achieved: by directly sending the motor parameters to the controller of the synchronous motor, the parameter generation process is kept offline, ensuring low computational overhead and hardware requirements for the controller, and achieving a cost-effective control scheme overall. By integrating an internal neural network into the controller and providing the trained weight values to the said internal neural network, the controller can update parameter identification results in real-time according to different operating conditions, enabling more reliable motor control.

According to a second aspect of the present invention, a device for parameter identification of a synchronous motor based on a neural network is provided. The device is used to perform the method according to the first aspect of the present invention and comprises:
a first identification module configured to establish and train a first neural network model and determine intermediate results of the parameters to be identified for the synchronous motor using the trained first neural network model;
a modification module configured to form a second neural network model by adding a compensation module in the trained first neural network model; and
a second identification module configured to train the second neural network model based on the intermediate results of the parameters to be identified and determine the final results of the parameters to be identified using the trained second neural network model.

According to a third aspect of the present invention, a computer program product is provided, wherein the computer program product comprises a computer program configured to implement the method according to the first aspect of the present invention when executed by a computer.

### DESCRIPTION OF THE DRAWINGS

The present invention is described in greater detail with reference to the accompanying drawings to provide a better understanding of its principles, features, and advantages. The drawings include:

FIG. 1 illustrates a flowchart of a neural network-based parameter identification method for a synchronous motor according to an exemplary example of the present invention;

FIG. 2 illustrates a flowchart of a method step shown in FIG. 1;

FIG. 3 illustrates a flowchart of two method steps shown in FIG. 1;

FIG. 4 shows a schematic diagram of a device for neural network-based parameter identification of a synchronous motor according to an exemplary example of the present invention;

FIG. 5 illustrates a schematic diagram of the operation points that need to be traversed for parameter identification using the lookup table method;

FIG. 6 illustrates a conceptual schematic diagram of the nonlinear characteristics of the d-axis magnetic flux of the synchronous motor;

FIG. 7 illustrates an exemplary schematic diagram of the first neural network model used in the method according to the present invention;

FIG. 8 illustrates an exemplary schematic diagram of the compensation module used in the method according to the present invention;

FIG. 9 illustrates an exemplary schematic diagram of the second neural network model used in the method according to the present invention; and

FIG. 10a-10b show schematic diagrams of the partial nonlinear characteristic portions of the d-axis inductance and q-axis inductance of the synchronous motor determined by the method according to the present invention as they vary with the current.

SPECIFIC EMBODIMENTS

In order to provide a clearer understanding of the technical problem, technical solution, and beneficial technical effects of the present invention, the following description is given in further detail in conjunction with the accompanying drawings and multiple exemplary examples. It should be understood that the specific embodiments described herein are provided only for the purpose of explaining the invention and not limiting the scope of protection of the invention.

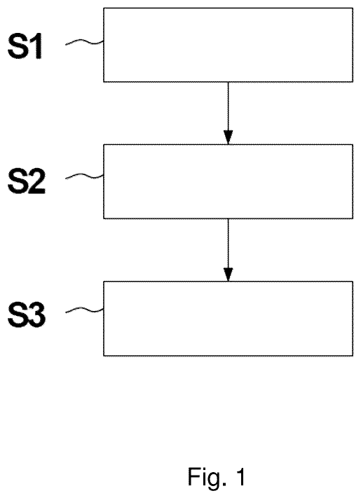

FIG. 1 shows a flowchart of a neural network-based parameter identification method for a synchronous motor according to an exemplary example of the present invention.

In Step S1, a first neural network model is established and trained to determine the intermediate results of the parameters to be identified for the synchronous motor.

The synchronous motor, in the context of the present invention, may include synchronous reluctance motors, permanent magnet synchronous motors, induction motors, and other types of synchronous motors with parameter nonlinearity.

In the context of the present invention, the parameters to be identified for the synchronous motor may include, for example, the stator resistance R, the d-axis inductance L_{d}, the q-axis inductance L_{q}, and/or the permanent magnet flux linkage φ_{f}. Among these parameters, the stator resistance R and the permanent magnet flux linkage φ_{f} may be considered to be inherent parameters of the synchronous motor and therefore do not change with the control of the outside temperature. However, due to the unavoidable iron core saturation phenomenon and material factors, the d-axis inductance L_{d} and q-axis inductance L_{q} of the synchronous motor will vary with changes in current. Treating them as constants would inevitably affect the control precision and stability of the motor.

In the context of the present invention, the intermediate results of the parameters to be identified include, for example, the linear approximation values of the first parameter (e.g., d-axis inductance L_{d} and q-axis inductance L_{q}) to be identified. Furthermore, these intermediate results also include: the first estimated value of the second parameter (e.g., stator resistance R and permanent magnet flux linkage φ_{f}) among the parameters to be identified, considering the linear approximation of the first parameter.

In this step, the input-output relationship of the first neural network model is established, for example, based on the synchronous motor's static voltage state equations in the d-q coordinate system. Taking the example of a permanent magnet synchronous motor, the static voltage state equations used are as follows:

$${U}_{sd} = {Ri}_{sd} - {ω}_{1} {L}_{q} {i}_{sq} + {ω}_{1} \vert {φ}_{f} \vert sin θ$$

$${U}_{sq} = {Ri}_{sq} + {ω}_{1} {L}_{d} {i}_{sd} + {ω}_{1} \vert {φ}_{f} \vert cos θ$$

Where U_{sd} is the d-axis voltage of the synchronous motor, R is the stator resistance of the synchronous motor, ω₁ is the electrical angular velocity of the synchronous motor, L_{q} is the q-axis inductance of the synchronous motor, i_{sq} is the q-axis current of the synchronous motor, |φ_{f}| is the amplitude of the permanent magnet flux linkage of the synchronous motor, θ is the zero angle of the synchronous motor, and U_{sq} is the q-axis voltage, i_{sd} is the d-axis current of the synchronous motor, and L_{d} is the d-axis inductance.

To establish a first neural network model, for instance, the q-axis current and d-axis current and the angular velocity of the synchronous motor are used as inputs of the first neural network model and the q-axis voltage and d-axis voltage as outputs of the first neural network model to characterize the modifiable weight of the first neural network model using R, L_{d}, L_{q}, and φ_{f} as the parameters to be identified.

In Step S2, a second neural network model is formed by adding a compensation module to the trained first neural network model. To describe the nonlinearity of the parameters to be identified, for example, a third neural network model is established as the compensation module, using the q-axis current and d-axis current as inputs, and the nonlinear characteristic portions of the d-axis inductance and q-axis inductance to be identified as outputs.

In step S3, the second neural network model is trained based on intermediate results derived from the parameters to be identified. The final results of the parameters to be identified are determined using the trained second neural network model. In the context of the present invention, the term “final results” refers to the outcomes that can characterize the actual values or actual functional relationships of the parameters to be identified. For instance, the final results of the parameters to be identified may include the linear approximation values of the first parameter (e.g., d-axis inductance and q-axis inductance) after being compensated for nonlinearity. Furthermore, the final results also include: after compensating the linear approximation value of the first parameter for nonlinearity, the second estimated value of the second parameter (e.g., stator resistance R and permanent magnet flux linkage φ_{f}) in the parameters to be identified no longer substantially or only slightly contains the nonlinear component contributions of the first parameter, compared to the previously determined first estimated value. By excluding this part, the second estimated value of the parameters approaches their true values more closely. In this step, for example, by using the second neural network model to update the intermediate results of the already determined parameters to be identified, the identification equations of each unknown parameter can be determined based on the updated results.

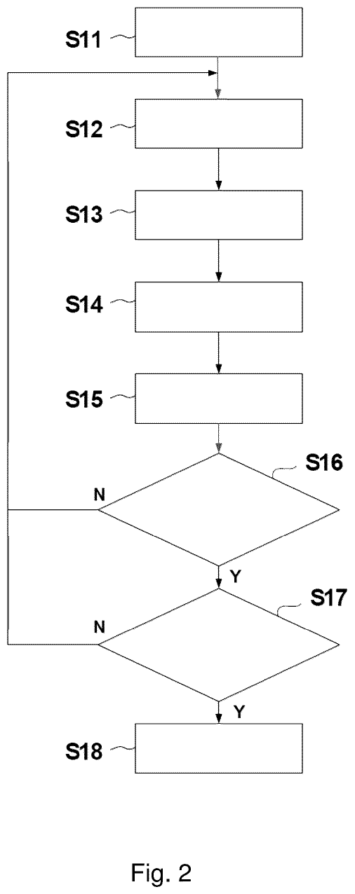

FIG. 2 shows a flowchart of a method step of the method shown in FIG. 1. In this example, the method step S1 in FIG. 1 includes steps S11-S18 by way of example.

In step S11, observation data is obtained. Taking a permanent magnet synchronous motor as an example, stable operation of the permanent magnet synchronous motor is controlled initially. Then, by changing the reference current, load torque, motor speed, and other conditions, N sets of different operating points are traversed in as wide a working range as possible, and the d-axis voltage U_{sd}, q-axis voltage U_{sq}, d-axis current i_{sd}, q-axis current i_{sq}, and electrical angular velocity ω₁ of the motor are recorded at these operating points. Here, the value of N can be adjusted freely according to the time consumption and the desired model precision, usually within the range of 15 to 30.

In step S12, the d-axis current i_{sd}, the q-axis current i_{sq}, and the electrical angular velocity ω₁ in a set of data are extracted from the observation data and input into the first neural network model through forward propagation.

In step S13, the output of the first neural network model is calculated based on the initial estimated values of the weights between each layer of neurons. Here, the initial estimated values of at least some of the weights of the first neural network model describe the values of the motor's parameters to be identified R, L_{d}, L_{q}, and φ_{f} under the condition of neglecting the motor's nonlinear characteristics. These initial estimated values of the weights can be derived by engineering experts based on experience or can be any mathematically and physically meaningful values externally input at random.

In step S14, the output error is calculated. For example, the deviation between the d- axis voltage Û_{sd} output by the first neural network model and the d-axis voltage Uₛd extracted from the observation data in step S12 is calculated, and the deviation between the q-axis voltage Û_{sq} output by the first neural network model and the q-axis voltage U_{sq} extracted from the observation data is also calculated.

In step S15, the connection weights are adjusted using a backpropagation algorithm based on the obtained errors. Here, the error update values are propagated layer by layer to reach the first layer through backpropagation, and all weights are updated together at the end of the backpropagation process. Depending on the required model precision and time consumption, the learning rate used in the backpropagation algorithm can be freely adjusted.

In step S16, it is checked whether the observation data used for training the model has been exhausted. For example, it checks if the number of traversed observation data is greater than or equal to N.

If not exhausted, the process returns from step S16 to step S12 to continue extracting the next training sample.

If exhausted, in step S17, the total loss function is calculated for all training samples (i.e., all observation data), and it is determined whether the output result of the loss function satisfies the first predetermined condition. For example, it checks whether the output result of the loss function is less than the first limit value.

If the output result of the loss function is greater than the first limit value, it indicates that the model's performance has not met the standard yet and needs to continue training. Therefore, it jumps back to step S12 from step S17 to start a new iteration loop.

If the output result of the loss function is less than the first limit value, it indicates that the model has already achieved satisfactory performance in the expected results. In this case, in step S18, the current weights of the first neural network model are output, and based on this, the linear approximation part of the parameters to be determined of the synchronous motor is determined. It is worth noting that since nonlinear factors of the synchronous motor are not considered at this stage, the parameters determined here are represented in constant form. For the first parameters that should be affected by nonlinear factors (such as d-axis and q-axis inductances), the results obtained at this stage can be seen as the average values of these parameters across all observation data, thus not being absolutely accurate. They will need to be corrected through subsequent nonlinear compensation processes. As for the second parameters that should be constant (such as stator resistance and permanent magnet flux linkage), the determined results at this stage also include a part of the nonlinear contribution from the first parameters.

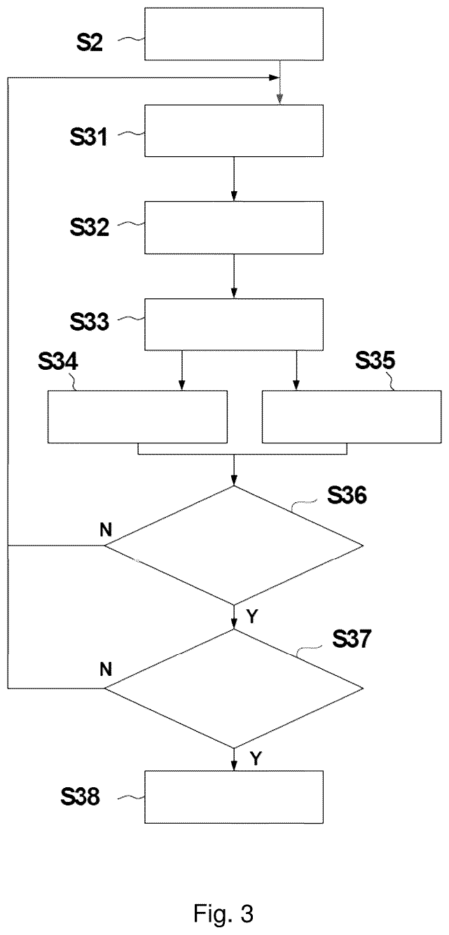

FIG. 3 shows the flowchart of two method steps in FIG. 1. In this embodiment, the method step S3 in FIG. 1 is exemplarily represented by steps S31-S38.

In step S2, the compensation module in the form of the third neural network model is added to the trained first neural network model, forming the second neural network model.

In step S31, a set of data consisting of d-axis current (i_{sd}), q-axis current (i_{sq}), and electrical angular velocity (ω₁) is extracted from the acquired observation data and input into the second neural network model through forward propagation. For example, the d-axis current (i_{sd}), q-axis current (i_{sq}), and electrical angular velocity (ω₁) are input into the trained first neural network model, and the d-axis current (i_{sd}) and q-axis current (i_{sq}) are also input into the compensation module.

In step S32, the output of the second neural network model is computed. For example, the corresponding voltages (Û_{sd}, Û_{sq}) are calculated based on the weight relationships between the neurons in each layer.

In step S33, the error between the output voltage of the second neural network model and the voltage in the observation data is computed.

In step S34, the weights of the trained first neural network model are adjusted based on this error using the backpropagation algorithm. The weights of the first neural network model still partly describe the motor parameters R, L_{d}, L_{q}, φ_{f}. However, since the intermediate results L_{d0}, L_{q0} for L_{d}, L_{q} have already represented the linear characteristic portions, they are no longer involved in further training. Nevertheless, the values of R and φ_{f} mistakenly include a part of the nonlinear contribution from L_{d}, L_{q}, so they need to be compensated for. Thus, when adjusting the weights of the trained first neural network model, only R and φ_{f} are changed.

In step S35, the network weights of the third neural network model (compensation module) are adjusted. Here, for example, the overall output error of the second neural network model is used to indirectly influence the output values of the third neural network model, thereby indirectly modifying the internal weights of the third neural network model.

In step S36, it is checked whether the observation data used for training the model has been exhausted.

If not exhausted, return from step S36 to step S31 to continue extracting the next training sample.

If exhausted, then in step S37, the total loss function is computed for all training samples (i.e., all observation data), and it is determined whether the output result of the loss function satisfies the second predetermined condition, i.e., whether it is less than the second limit value.

If the output result of the loss function is greater than the second limit value, then return from step S37 to step S31 to start a new iteration loop.

If the output result of the loss function is less than the second limit value, it indicates that the model has achieved satisfactory performance in the expected results. In this case, in step S38, the current weights of the second neural network model are output, and based on this, the final values of R and φ_{f} in the parameters to be identified of the synchronous motor are determined. Furthermore, with the aid of the output of the third neural network model, the nonlinear characteristics portions ΔL_{d0} and ΔL_{q0} of the fitted L_{d} and L_{q} are obtained. By combining these with the linear characteristic portions L_{d0} and L_{q0} determined using the first neural network model, the functional relationship between L_{d}, L_{q}, and the current can be ultimately determined.

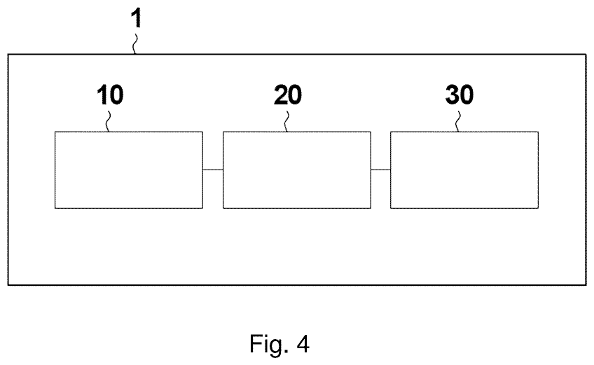

FIG. 4 shows a schematic diagram of a device for neural network-based parameter identification of a synchronous motor according to an exemplary example of the present invention.

As shown in FIG. 4, the device 1 comprises a first identification module 10, a modification module 20, and a second identification module 30. The first identification module 10 and the second identification module 30 are both used to identify unknown parameters of the synchronous motor but have different task focuses. For example, the first identification module 10 is primarily used to determine the linear characteristic portions of the parameters to be identified or the parameter values under linear approximation, while the second identification module 20 is mainly used to determine the results considering nonlinear factors or the results after nonlinear compensation.

Specifically, the first identification module 10 is used, for example, to establish and train a first neural network model and utilize the trained model to determine intermediate results of the parameters to be identified of the synchronous motor.

The modification module 20 is used, for example, to form a second neural network model by adding a compensation module to the trained first neural network model.

The second identification module 20 is used, for example, to train the second neural network model based on the intermediate results of the parameters to be identified and utilize the trained second neural network model to determine the final results of the parameters to be identified.

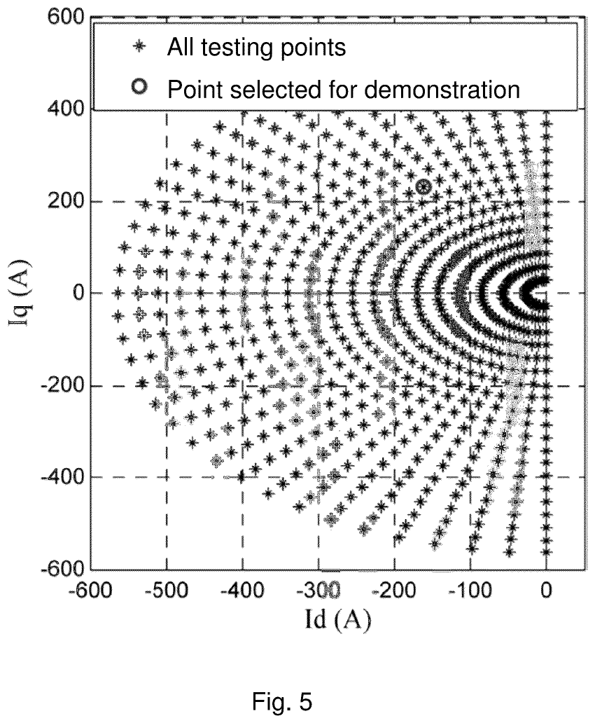

FIG. 5 shows a schematic diagram of the operation points that need to be traversed for parameter identification using the lookup table method.

In order to comprehensively reflect the nonlinear characteristics of specific parameters (e.g., d-axis inductance and q-axis inductance) of the synchronous motor, it is necessary to cover the entire operating range of the synchronous motor with operation points as comprehensively as possible. Therefore, it can be seen from FIG. 5 that numerous operation points need to be collected and tested. Moreover, since magnetic saturation phenomena are more significant at low currents, it is particularly necessary to increase the sampling rate intensively at low currents, which greatly increases the time consumption of parameter identification. Additionally, the accuracy of the sampled data itself is also limited by the precision of measurement software/hardware.

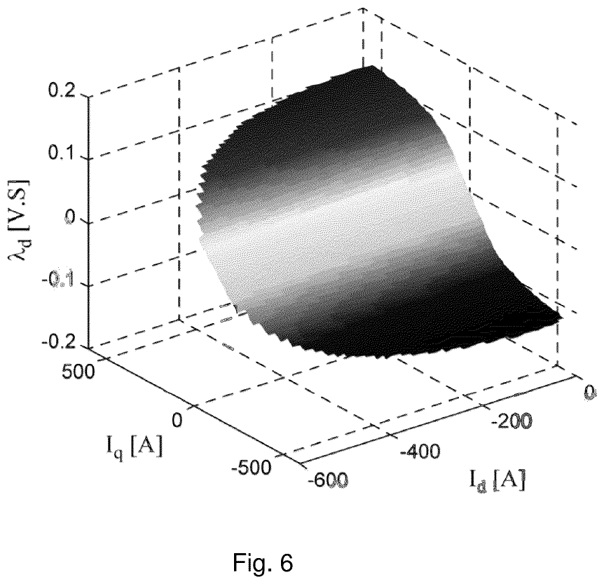

FIG. 6 shows a conceptual schematic diagram of the nonlinear characteristics of the d-axis magnetic flux of the synchronous motor.

In an ideal situation, the d-axis magnetic flux should vary linearly with the corresponding current, forming a plane. However, as shown in FIG. 6, the d-axis magnetic flux exhibits a nonlinear relationship with the d-axis and q-axis currents due to saturation, which is visually represented as an irregular surface. This nonlinearity further causes the d- axis inductance to vary with changes in current. Treating it as a constant will inevitably affect the control precision and stability of the motor.

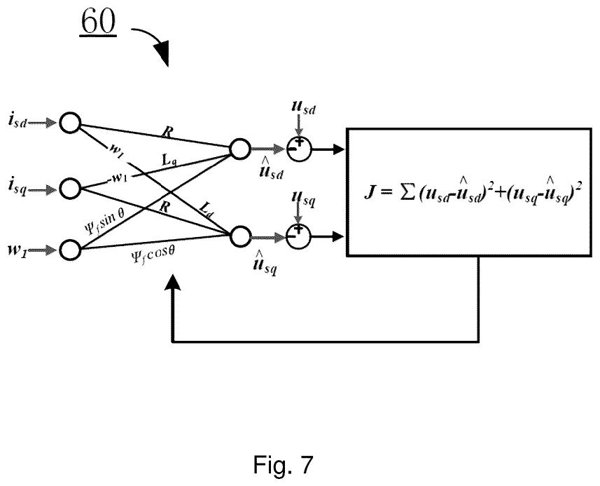

FIG. 7 illustrates an exemplary schematic diagram of the first neural network model used in the method according to the present invention.

The first neural network model 60 comprises a two-layer neuron structure and is fully connected in each layer. The input and output relationships are established using the following static voltage state equations in the d-q coordinate system by synchronous motors:

$${U}_{sd} = {Ri}_{sd} - {ω}_{1} {L}_{q} {i}_{sq} + {ω}_{1} \vert {φ}_{f} \vert sin θ$$

$${U}_{sq} = {Ri}_{sq} + {ω}_{1} {L}_{d} {i}_{sd} + {ω}_{1} \vert {φ}_{f} \vert cos θ$$

where U_{sd} is the d-axis voltage of the synchronous motor, R is the stator resistance of the synchronous motor, ω₁ is the electrical angular velocity of the synchronous motor, L_{q} is the q-axis inductance of the synchronous motor, iₛq is the q-axis current of the synchronous motor, |φ_{f}| is the amplitude of the permanent magnet flux linkage of the synchronous motor, θ is the zero angle of the synchronous motor, U_{sq} is the q-axis voltage, i_{sd} is the d-axis current of the synchronous motor, and L_{d} is the d-axis inductance of the synchronous motor.

To determine the linear characteristic portions of the parameters to be identified of the synchronous motor using the first neural network model 60, the q-axis current i_{sq}, d-axis current i_{sd}, and electrical angular velocity ω₁ of the synchronous motor are used as inputs to the first neural network model 60, while the q-axis voltage U_{sq} and d-axis voltage U_{sd} are used as outputs of the first neural network model 60. Based on the mapping relationship defined by the static voltage state equations, the weights between the first input node and the two output nodes are Rand ω₁, between the second input node and the two output nodes are −ω₁ and R, and between the third input node and the two output nodes are |φ_{f}|sin θ and |φ_{f}|cos θ. In the case where the zero angle of the motor is correctly calibrated, θis 0. Here, R, L_{d}, L_{q}, and φ_{f} are adjustable weights of the first neural network model 60, and their values can be iteratively updated in the backpropagation process.

For each given input, the first neural network model 60 outputs estimated values of q-axis voltage and d-axis voltage. A loss function may be constructed based on the difference between the measured voltage and the estimated values:

$$J = {\sum }_{0}^{N} {( {U}_{sd} - {\hat{U}}_{sd} )}^{2} + {( {U}_{sq} - {\hat{U}}_{sq} )}^{2}$$

where N is the number of known observation data used, U_{sd} is the d-axis voltage of the synchronous motor in the known observation data, Û_{sd} is the output d-axis voltage of the first neural network model 60, U_{sq} is the q-axis voltage of the synchronous motor in the known observation data, and Û_{sq} is the output q-axis voltage of the first neural network model 60.

The weights of the network are modified at least partially using the backpropagation algorithm until the value of the loss function J satisfies the first predetermined condition. At this point, the intermediate results of the parameters to be identified R, L_{d}, L_{q}, and φ_{f} can be determined based on the internal weights of the first neural network model 60.

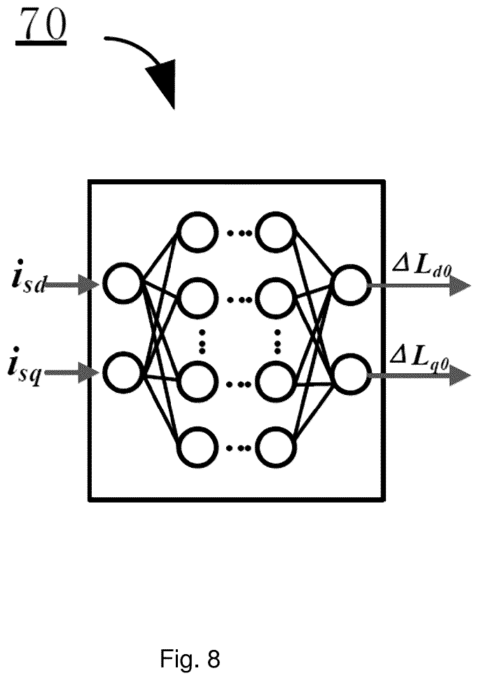

FIG. 8 shows an exemplary schematic diagram of the compensation module used in the method according to the present invention.

The compensation module 70 in the form of the third neural network model exemplarily comprises an input layer, an output layer, and at least one hidden layer. Depending on the desired precision and the amount of observation data, the number of hidden layers and the number of neurons contained can be adjusted. To fit the nonlinear characteristics of the q-axis inductance L_{q} and the d-axis inductance L_{d}, it is assumed that L_{q} and L_{d} are each composed of two parts, expressed as follows:

$${L}_{d} = {L}_{d 0} + Δ {L}_{d 0}$$

$${L}_{q} = {L}_{q 0} + Δ {L}_{q 0}$$

where L_{q} and L_{d} are respectively the q-axis inductance and the d-axis inductance, L_{d0} and L_{q0} represent the linear characteristic portion of the q-axis inductance and the d-axis inductance, and ΔL_{d0} and ΔL_{q0} represent the nonlinear characteristic portion of the q-axis inductance and the d-axis inductance. For example, ΔL_{d0} and ΔL_{q0} have been determined in the form of intermediate results using the first neural network model. Therefore, the purpose is to determine ΔL_{d0} and ΔL_{q0} using the nonlinear compensation module 70. As the magnetic circuit saturation of the synchronous motor is highly related to the d-axis and q-axis currents i_{sd} and i_{sq}, based on this understanding, a direct relationship between i_{sd}, i_{sq}, and ΔL_{d0}, ΔL_{q0} is established in the compensation module. In other words, the q-axis current and d-axis current i_{sd}, i_{sq} are used as inputs to the third neural network model, and the nonlinear characteristic portions of the parameters to be identified ΔL_{d0}, ΔL_{q0} are used as outputs of the third neural network model.

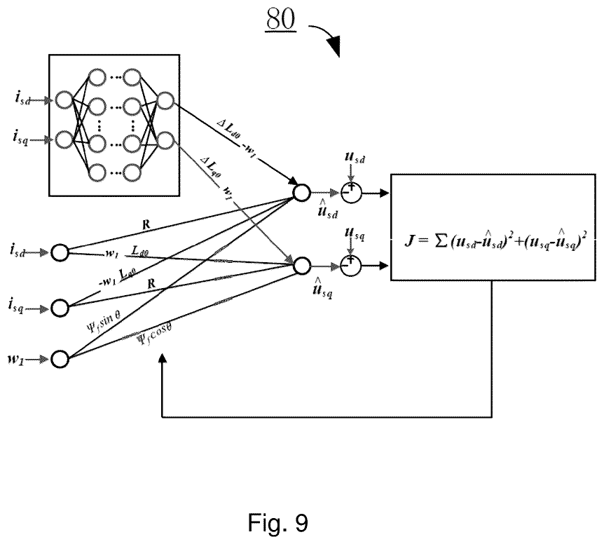

FIG. 9 illustrates an exemplary schematic diagram of the second neural network model used in the method according to the present invention.

Here, the compensation module 70 shown in FIG. 8 is added to the first neural network model 60 shown in FIG. 7, such that the compensation module 70 shares a portion of the input layer with the first neural network model 60, i.e., sharing “d, q-axis currents i_{sd}, i_{sq}.” The output layer of the compensation module 70 is fully connected to the output layer of the first neural network model 60, thus forming the overall second neural network model 80.

Overall, the inputs of the second neural network model 80 are still the q-axis current i_{sq}, d-axis current i_{sd}, and the synchronous motor's electrical angular velocity ω₁. The outputs of the second neural network model 80 are still the q-axis voltage U_{sq} and d-axis voltage U_{sd}. However, due to the consideration of nonlinear factors, the input-output relationship of the second neural network model 80 is established based on the following static voltage state equations:

$${U}_{sd} = {Ri}_{sd} - {ω}_{1} {L}_{q 0} {i}_{sq} - {ω}_{1} Δ {L}_{q 0} {i}_{sq} + {ω}_{1} \vert {φ}_{f} \vert sin θ$$

$${U}_{sq} = {Ri}_{sq} + {ω}_{1} {L}_{q 0} {i}_{sq} + {ω}_{1} Δ {L}_{q 0} {i}_{sd} + {ω}_{1} \vert {φ}_{f} \vert cos θ$$

where U_{sd} is the d-axis voltage of the synchronous motor, R is the stator resistance of the synchronous motor, ω₁ is the electrical angular velocity of the synchronous motor, L_{q0} is the linear characteristic portion of the q-axis inductance of the synchronous motor, ΔL_{q0} is the nonlinear characteristic portion of the q-axis inductance of the synchronous motor, iₛq is the q-axis current of the synchronous motor, |φ_{f}| is the amplitude of the permanent magnet flux linkage of the synchronous motor, θ is the zero angle of the synchronous motor, U_{sq} is the q-axis voltage, i_{sd} is the d-axis current, L_{d0} is the linear characteristic portion of the d-axis inductance, and ΔL_{d0} is the nonlinear characteristic portion of the d-axis inductance.

During the training of the second neural network model 80, concerning the first neural network model 60, the adjustment is made starting from the weight values obtained at the end of training of the first neural network model 60. To facilitate compensation through the nonlinear characteristic portion, it is assumed that the linear characteristic portions L_{d0} and L_{q0} of the d-and q-axis inductances are fixed, so that the weights represented by these two characterizations do not participate in the second iteration training. Therefore, only the values of R and φ_{f} are changed in the adjustment process.

Regarding the compensation module 70 (i.e., the third neural network model), the predetermined values of the internal weights of this network are changed to alter the output of ΔL_{d0} and ΔL_{q0}.

This iterative process of updating weights continues until the following loss function converges:

$$J = {\sum }_{0}^{N} {( {U}_{sd} - {\hat{U}}_{sd} )}^{2} + {( {U}_{sq} - {\hat{U}}_{sq} )}^{2}$$

where N is the number of known observation data used, U_{sd} is the d-axis voltage of the synchronous motor in the known observation data, Û_{sd} is the output d-axis voltage from the second neural network model, U_{sq} is the q-axis voltage of the synchronous motor in the known observation data, and Û_{sq} is the output q-axis voltage from the second neural network model.

When the training of the second neural network model 80 is completed, the final results for the parameters to be identified R and φ_{f} can be determined based on the internal weights of the corresponding first neural network model 60. Additionally, at the completion of training, with the assistance of the compensation module 70, the nonlinear characteristic portions ΔL_{d0} and ΔL_{q0} of the fitted L_{d} and L_{q}, combined with the linear characteristic portions L_{d0} and L_{q0}, can be used to determine the functional relationship between L_{d}, L_{q}, and the d-axis and q-axis currents.

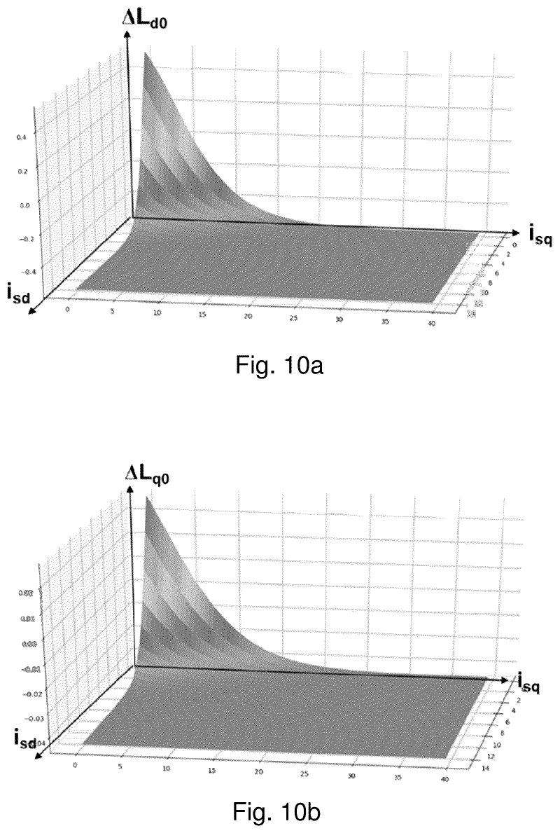

FIGS. 10a and 10b show schematic diagrams of the nonlinear characteristic portions of the d-axis inductance and q-axis inductance of the synchronous motor determined by the method according to the present invention as they vary with the current.

From FIGS. 10a and 10b, it can be observed that, with the help of the compensation module, the nonlinear characteristic portions ΔL_{d0} and ΔL_{q0} of the d-axis and q-axis inductances can be fitted against the variation of d-and q-axis currents i_{sd}, i_{sq}, forming surface plots. Based on the neural network technology used, intelligent reasoning and judgment can be applied to the unknown portions of the surface based on limited observation data points, enabling automatic interpolation and reconstruction of missing data to restore the complete functional relationship between ΔL_{d0}, ΔL_{q0}, and the current. From the fitting results, it can be seen that the nonlinear characteristic portions of the d-axis and q-axis inductances are not constants, but vary due to the effects of magnetic flux nonlinearity caused by phenomena such as magnetic saturation in the synchronous motor. The nonlinear characteristics are more pronounced especially when the current values i_{sd} and i_{sq} are small.

Although specific embodiments of the present invention have been described in detail here, they are provided solely for explanatory purposes and should not be construed as limiting the scope of the invention. Various substitutions, alterations, and modifications can be conceived without departing from the spirit and scope of the present invention.

1. A method for parameter identification of a synchronous motor based on a neural network, comprising:
S1) establishing and training a first neural network model to determine intermediate results of parameters to be identified for the synchronous motor using the trained first neural network model;
S2) forming a second neural network model by adding a compensation module to the trained first neural network model; and
S3) training the second neural network model based on the intermediate results of the parameters to be identified to determine the final results of the parameters to be identified using the trained second neural network model.

2. The method according to claim 1, wherein the intermediate results comprise:
a linear approximation value of a first parameter in the parameters to be identified; and
a first estimated value of a second parameter in the parameters to be identified under the linear approximation of the first parameter.

3. The method according to claim 1, wherein the final results comprise:
the linear approximation value of the first parameter in the parameters to be identified after being compensated for nonlinearity; and
a second estimated value of the second parameter in the parameters to be identified after compensating for the nonlinearity of the linear approximation value of the first parameter.

4. The method according to claim 1, wherein the parameters to be identified for the synchronous motor include stator resistance, d-axis inductance, q-axis inductance, and permanent magnet flux of the synchronous motor.

5. The method according to claim 1, wherein step S1 comprises:
establishing an input-output relationship for the first neural network model based on the static voltage state equations of the synchronous motor in the d-q coordinate system, wherein the inputs of the first neural network model comprise q-axis current, d-axis current, and synchronous motor electrical angular velocity, while the outputs of the first neural network model comprises q-axis voltage and d-axis voltage of the synchronous motor, the weights of the first neural network model are at least partially represented by the parameters to be identified.

6. The method according to claim 5, wherein step S1 comprises:
obtaining known observation data of the synchronous motor, said known observation data includes d-axis current, q-axis current, d-axis voltage, q-axis voltage, and electrical angular velocity of the synchronous motor measured at different operating points;
training the first neural network model using the known observation data, wherein adjusting the weights of the first neural network model until the loss function satisfies a first predetermined condition; and
determining intermediate results of the synchronous motor's parameters to be identified based on the weights of the first neural network model when the loss function satisfies the first predetermined condition.

7. The method according to claim 6, wherein adjusting the weights of the first neural network model comprises: iteratively updating the weights of the first neural network model using a gradient descent algorithm.

8. The method according to claim 1, wherein step S2 comprises:
establishing a third neural network model as the compensation module, with q-axis current and d-axis current as inputs to the third neural network model, and the nonlinear characteristic portion of the first parameter in the parameters to be identified as the output of the third neural network model.

9. The method according to claim 1, wherein step S2 comprises:
adding the compensation module to the first neural network model as follows:
sharing a part of the input layer of the first neural network model with the input layer of the compensation module, and connecting the output layer of the compensation module to the output layer of the first neural network model.

10. The method according to claim 1, wherein step S3 comprises:
training the second neural network model using the known observation data, wherein adjusting the weights of the trained first neural network model and the weight of the compensation module until the loss function satisfies a second predetermined condition; and
determining the final results of the parameters to be identified of the synchronous motor based on the weights of the first neural network model and the weight of the compensation module when the loss function satisfies the second predetermined condition.

11. The method according to claim 10, wherein while adjusting the weights of the trained first neural network model, the intermediate results of the first parameter in the parameters to be identified are kept unchanged, and the intermediate results of the second parameter in the parameters to be identified are changed.

12. The method according to claim 6, wherein the loss function is represented by the following formula:
$$J = {\sum }_{0}^{N} {( {U}_{sd} - {\hat{U}}_{sd} )}^{2} + {( {U}_{sq} - {\hat{U}}_{sq} )}^{2}$$
where N is the number of known observation data used, U_{sd} is the d-axis voltage of the synchronous motor in the known observation data, Û_{sd} is the d-axis voltage output by the first neural network model or the second neural network model, U_{sq} is the q-axis voltage of the synchronous motor in the known observation data, and Ûsq is the q-axis voltage output by the first neural network model or the second neural network model.

13. The method according to claim 1, wherein the method further comprises:
sending the final results of the parameters to be identified to the controller of the synchronous motor to control the operation of the synchronous motor based on the final results; and/or
sending the weights of the trained second neural network model to the internal neural network of the controller of the synchronous motor, allowing the internal neural network to determine the online final results of the parameters to be identified based on the operation parameters of the synchronous motor in real time when applying the weights of the second neural network model, and controlling the operation of the synchronous motor based on the online final results.

14. A neural network-based synchronous motor parameter identification device, the device being configured to perform the method according to claim 1, the device comprises:
a first identification module, configured to establish and train a first neural network model and determine intermediate results of the parameters to be identified for the synchronous motor using the trained first neural network model;
a modification module, configured to form a second neural network model by adding a compensation module to the trained first neural network model; and
a second identification module, configured to train the second neural network model based on the intermediate results of the parameters to be identified and determine the final results of the parameters to be identified using the trained second neural network model.

15. A computer program product, wherein the computer program product comprises a computer program configured to implement the method according to claim 1 when executed by a computer.

16. The method according to claim 7, wherein the gradient descent algorithm is a backpropagation algorithm.
